(19) United States
(12) Patent Application Publication
(10) Pub. No.: US 2004/0141129 A1
(43) Pub. Date: Jul. 22, 2004

(54) Method and structure of low reflection liquid crystal display unit

(76) Inventors: Shih-Chang Chang, Hsinchu (TW); Yaw-Ming Tsai, Taichung Hsien (TW)

Correspondence Address: SNELL & WILMER, ONE ARIZONA CENTER, 400 EAST VAN BUREN, PHOENIX, AZ, 850040001

(21) Appl. No.: 10/347,093

(22) Filed: Jan. 17, 2003

(51) Int. Cl. G02F 1/1343

(52) U.S. Cl. 349/139

(57) ABSTRACT

A method and structure of low reflection liquid crystal display unit are provided. The structure includes a semiconductor layer, a first metal layer, and a second metal layer. The method includes forming a semiconductor layer, forming an insulator layer on the semiconductor layer, forming a first metal layer on the insulator layer, forming a dielectric layer on the first metal layer, and forming a second metal layer on the dielectric layer. The first and second metal layers are located over the semiconductor layer. The first and/or second metal layer is extended to cover a portion of or entire the semiconductor layer.

### FIELD OF THE INVENTION

The present invention relates to the method and structure of low reflection liquid crystal display unit.

### BACKGROUND OF THE INVENTION

FIG. 1 is a top elevation of a liquid crystal display unit according to the prior art. A polysilicon layer 104, a first metal layer 108, and a second metal layer 112 are shown. A portion of the polysilicon layer 104 is not covered to increase the aperture ratio. However, the polysilicon layer 104 has high reflectivity and therefore deteriorates the efficiency of displays, e.g. reduction of the contrast. Besides, different reflectivity resulting from crystallization and different exposed areas of the polysilicon layer 104 cause “mura” when display is turned off.

Typical solution to the problems resulting from high reflectivity of the polysilicon layer is covering the exposed polysilicon layer with black matrix. The black matrix may be located at the color filter side or the thin film transistor side. However, when the black matrix is located at the color filter side, larger black matrix area is needed for tolerating mask misalignment. When the black matrix is located at the thin film transistor side, more complicated fabrication steps are needed.

Therefore method and structure of low reflection liquid crystal display unit, which can reduce effects caused by high reflectivity of the polysilicon layer with smaller black matrix or simpler fabrication technique, are needed.

### SUMMARY OF THE INVENTION

Method and structure of low reflection liquid crystal display unit, which can eliminate effects caused by high reflectivity of the polysilicon layer with smaller black matrix, are provided.

One aspect of the present invention provides method and structure of low reflection liquid crystal display unit, which can eliminate effects caused by high reflectivity of the polysilicon layer.

Another aspect of the present invention provides method and structure of low reflection liquid crystal display unit, which can eliminate effects caused by high reflectivity of the polysilicon layer with smaller black matrix and utilize simpler fabrication technique.

The main spirit of the present invention lies in extending the metal layer to cover the originally exposed polysilicon layer. The method of forming low reflection liquid crystal display unit is provided. The method may include following steps. A semiconductor layer is formed. An insulator layer is formed on the semiconductor layer. A first metal layer is formed on the insulator layer. A dielectric layer is formed on the first metal layer. And a second metal layer is formed on the dielectric layer. The first and second metal layers are located over the semiconductor layer. The first and/or second metal layer is extended to cover a portion of or entirety of the semiconductor layer. Herein a portion of the semiconductor layer is defined as not less than 70 percent of area of the semiconductor layer. The first metal layer may be used to form a storage capacitor electrode or a gate line. And the second metal layer may be used to form a data line.

The structure of low reflection liquid crystal display unit is also provided. The structure may include a semiconductor layer, a first metal layer, and a second metal layer. The first and second metal layers are located over the semiconductor layer. The first and/or second metal layer is extended to cover a portion of or entirety of the semiconductor layer. Herein a portion of the semiconductor layer is defined as not less than 70 percent of area of the semiconductor layer. The first metal layer may include a storage capacitor electrode or a gate line. And the second metal layer may include a data line.

### BRIEF DESCRIPTION OF THE DRAWINGS

FIG. 1 is a top elevation of a liquid crystal display unit according to the prior art;

FIG. 2 is a schematic diagram illustrating a method of one exemplary embodiment;

FIG. 3 is a top elevation of a first exemplary embodiment;

FIG. 4 is a top elevation of a second exemplary embodiment; and

FIG. 5 is a top elevation of a liquid crystal display unit according to a preferred exemplary embodiment.

### DETAILED DESCRIPTION

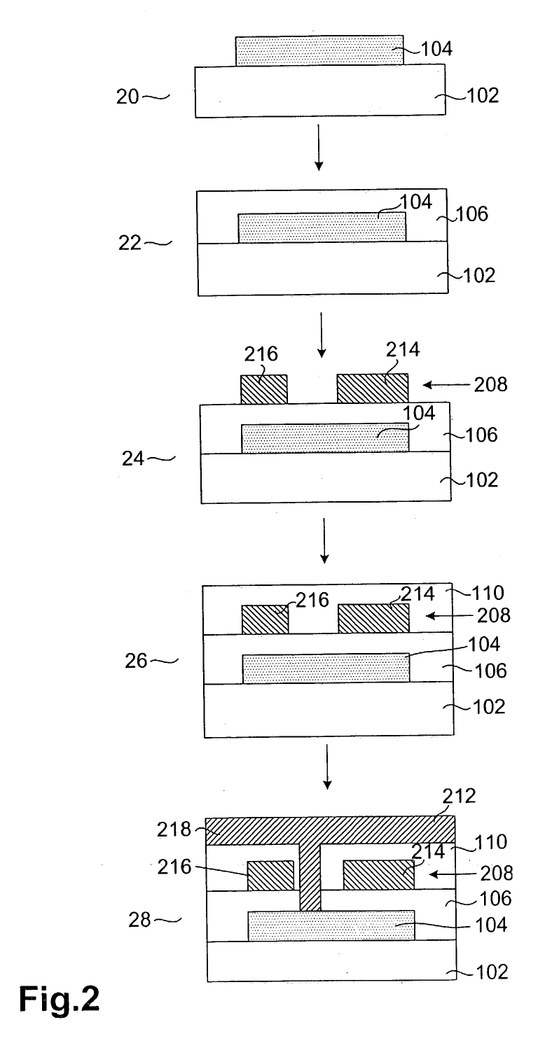

A method and structure of low reflection liquid crystal display unit are provided. The main spirit of the present invention lies in extending a metal layer to cover the originally exposed polysilicon layer. A schematic diagram shown in FIG. 2 is useful to illustrate a method according to one exemplary embodiment. A polysilicon layer 104 is formed on a substrate 102 (step 20). An insulator layer 106 is formed on the polysilicon layer 104 (step 22). A first metal layer 208 is formed on the insulator layer 106 (step 24). A dielectric layer 110 is formed on the first metal layer 208 (step 26). A second metal layer 212 is formed on the dielectric layer 110 (step 28). Both the first metal layer 208 and the second metal layer 212 are located over the polysilicon layer 104, and extend to cover a portion of or entirety of the polysilicon layer 104. The first metal layer 208 may be used to form, for example, a storage capacitor electrode 214 and a gate line 216. And the second metal layer 212 may be used to form, for example, a data line 218.

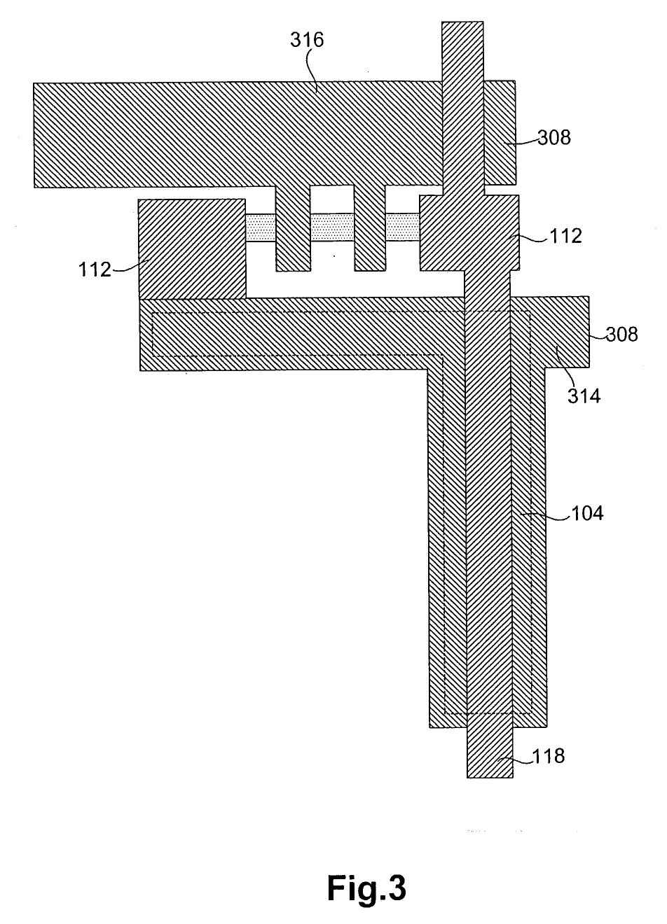

FIG. 3 is a top elevation of a first exemplary embodiment. The first metal layer 308 includes a storage capacitor electrode 314, and extends to cover a portion of the polysilicon layer 104. Herein a portion of the polysilicon layer 104 is defined as not less than 70 percent of area of the polysilicon layer 104.

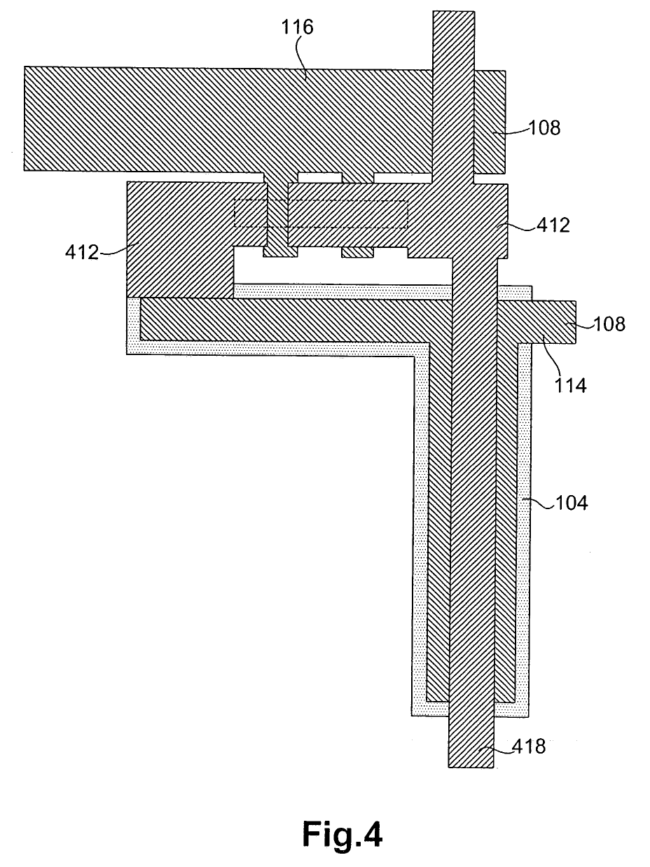

FIG. 4 is a top elevation of a second exemplary embodiment. The second metal layer 412 extends to cover a portion of the polysilicon layer 104. Herein a portion of the polysilicon layer 104 is defined as not less than 70 percent of area of the polysilicon layer 104.

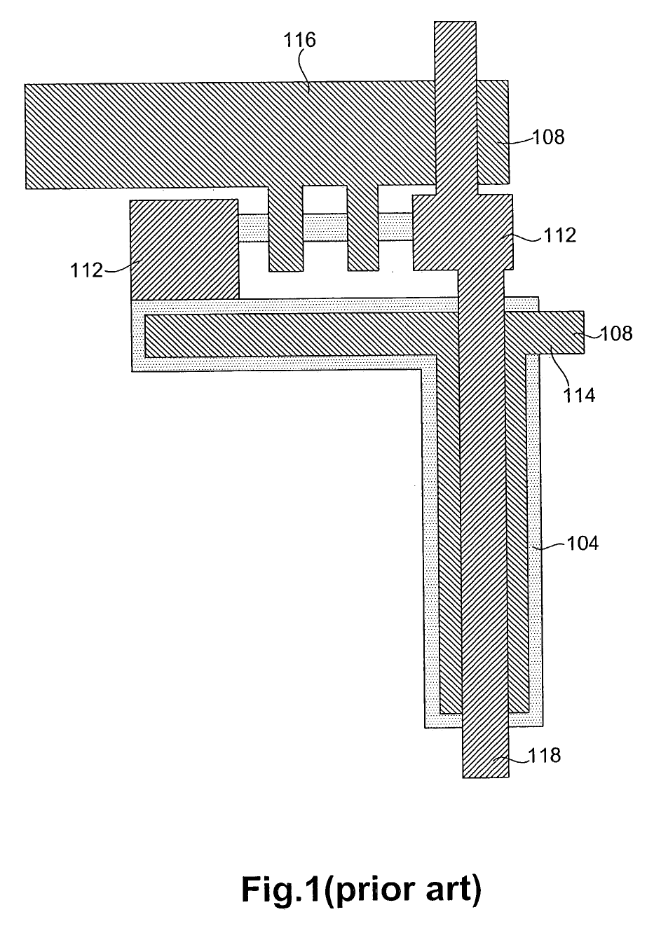

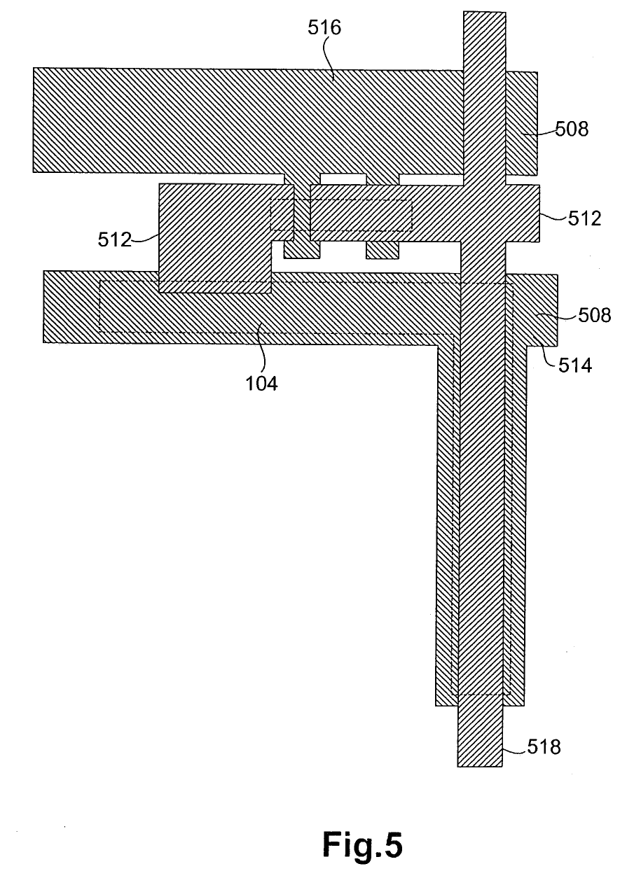

FIG. 5 is a top elevation of a liquid crystal display unit according to a preferred exemplary embodiment. In comparison with FIG. 1, the first metal layer 508 and the second metal layer 512 all extend to cover the originally exposed polysilicon layer 104 (indicated by dashed line). Therefore the effects caused by high reflectivity of the polysilicon layer 104 are eliminated with smaller black matrix using a simpler fabrication technique.

While this invention has been described with reference to the illustrative embodiments, these descriptions are not is intended to be construed in a limiting sense. Various modifications of the illustrative embodiments, as well as other embodiments of the invention, will be apparent upon reference to these descriptions. It is therefore contemplated that the appended claims will cover any such modifications or embodiments as falling within the true scope of the invention and its legal equivalents.

1. A method of fabricating a liquid crystal display unit on a substrate, said method comprising:
forming a semiconductor layer on said substrate;
forming an insulator layer on said semiconductor layer; and
forming a first metal layer on said insulator layer, said first metal layer being located over said semiconductor layer and covering a portion of or the entire said semiconductor layer.

2. The method of claim 1, wherein said first metal layer comprises a storage capacitor electrode or a gate line.

3. The method of claim 1, further comprising:
forming a dielectric layer on said first metal layer; and
forming a second metal layer on said dielectric layer, said second metal layer being located over said semiconductor layer and covering a portion of or entire said semiconductor layer.

4. The method of claim 3, wherein said second metal layer comprises a data line.

5. A method of fabricating a liquid crystal display unit on a substrate, said method comprising:
forming a semiconductor layer on said substrate;
forming an insulator layer on said semiconductor layer;
forming a first metal layer on said insulator layer;
forming a dielectric layer on said first metal layer; and
forming a second metal layer on said dielectric layer, said second metal layer being located over said semiconductor layer and covering a portion of or entire said semiconductor layer.

6. The method of claim 5, wherein said second metal layer comprises a data line.

7. The method of claim 5, wherein said first metal layer is located over said semiconductor layer and covers a portion of or entire said semiconductor layer.

8. The method of claim 7, wherein said first metal layer comprises a storage capacitor electrode or a gate line.

9. The method of claim 1, wherein said semiconductor layer comprises a polysilicon layer.

10. The method of claim 9, wherein said portion of said semiconductor layer is not less than approximately 70 percent of area of said semiconductor layer.

11. A liquid crystal display unit, comprising:
a semiconductor layer; and
a first metal layer being located over said semiconductor layer and covering a portion of or entire said semiconductor layer;
wherein said first metal layer is selected from the group consisting of a storage capacitor electrode and a gate line.

12. The liquid crystal display unit of claim 11 further comprising a second metal layer being located over said first metal layer and covering a portion of or entire said semiconductor layer.

13. The liquid crystal display unit of claim 12, wherein said second metal layer comprises a data line.

14. A liquid crystal display unit, comprising:
a semiconductor layer; and
a first metal layer being located over said semiconductor layer and covering a portion of or entire said semiconductor layer;
wherein said first metal layer comprises a data line.

15. The liquid crystal display unit of claim 14, further comprising a second metal layer being between said semiconductor layer and said first metal layer, said second metal layer covering a portion of or entire said semiconductor layer.

16. The liquid crystal display unit of claim 15, wherein said second metal layer comprises a storage capacitor electrode.

17. The liquid crystal display unit of claim 16, wherein said second metal layer comprises a gate line.

18. The liquid crystal display unit of claim 13, wherein said semiconductor layer comprises a polysilicon layer.

19. The liquid crystal display unit of claim 11, wherein said semiconductor layer comprises a polysilicon layer.

20. The liquid crystal display unit of claim 19, wherein said portion of said semiconductor layer is not less than approximately 70 percent of area of said semiconductor layer.

21. The liquid crystal display unit of claim 20, wherein said portion of said semiconductor layer is not less than approximately 70 percent of area of said semiconductor layer.
